(19) United States
(12) Patent Application Publication
(10) Pub. No.: US 2004/0211770 A1
(43) Pub. Date: Oct. 28, 2004

(54) Electric heater assembly

(75) Inventors: Ian J. Renwick, West Chicago, IL (US); John Ori, Arlington Heights, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Fast Heat, Inc., Elmhurst, IL (US)

(21) Appl. No.: 10/420,080

(22) Filed: Apr. 22, 2003

(51) Int. Cl. H05B 3/54

(52) U.S. Cl. 219/541; 219/549

(57) ABSTRACT

An electric heater assembly is provided. The heater assembly includes an electrically operable heating element and a pair of power leads for supplying electrical power to the heating element. Each of the power leads is connected to a respective end of the heating element by a connector. A watertight seal is provided at the connection of each power lead to the heating element. Each watertight seal includes a sealing sleeve arranged over the respective connector and a sealing compound provided between the sealing sleeve and the respective connector. The heating element, the connectors and the watertight seals are arranged in a housing. The housing includes a pair of openings with each power lead extending through a respective one of the pair of openings. Each of the openings has a rounded smooth edge defined by a portion of the housing that is folded back on itself.

### FIELD OF THE INVENTION

This invention pertains to electric heater assemblies.

### BACKGROUND OF THE INVENTION

Electric heater assemblies having a strip or band like configuration are used in a variety of different applications in which they are exposed to moisture. For example, such heater assemblies are commonly used in air conditioning units that are located outdoors. In particular, the heater assembly is wrapped around the compressor of the air conditioning unit in order to maintain the temperature of the liquid and/or gas contained in the compressor at a predetermined elevated level. Because of their outdoor location, the heater assemblies are often exposed to adverse weather conditions such as rain, snow and ice. In some cases, such as where the air conditioning unit is installed near the ocean, the heater can be exposed to salt water. Additionally, since the electric heater assembly is not always energized, moisture can accumulate on the heater and freeze in cold weather conditions.

This exposure to salt water, rain, snow or ice can lead to problems with the electrical connections between the internal resistive heating element of the electric heater assembly and the power leads attached to the element. While waterproof and weather resistant band type electric heater assemblies are known, they utilize relatively bulky sealing structures that can make the heater assemblies inconvenient to use such as by making it more difficult to form the heater assembly into different shapes.

Another problem with band type electric band heater assemblies is that during the handling and installation of the heater assembly, the insulation of the power lead can be damaged, exposing the current carrying strands of the power lead. The damage is caused when the insulation of the power lead is inadvertently rubbed against the sharp metal edge of the housing of the heater assembly. Obviously, exposure of the current carrying strands of the power lead can lead to a potentially dangerous electrical condition particularly in applications where the heater assembly is exposed to moisture.

### BRIEF SUMMARY OF THE INVENTION

The invention provides an improved electric heater assembly. The heater assembly includes an electrically operable heating element and a pair of power leads for supplying electrical power to the heating element. Each of the power leads is connected to a respective end of the heating element by a connector. A watertight seal is provided at the connection of each power lead to the heating element. Each watertight seal includes a sealing sleeve arranged over the respective connector and a sealing compound provided between the sealing sleeve and the respective connector. The heating element, the connectors and the watertight seals are arranged in a housing.

In an alternative embodiment, the housing includes a pair of openings with each power lead extending through a respective one of the pair of openings. Each of the openings has a rounded smooth edge defined by a portion of the housing that is folded back on itself.

### BRIEF DESCRIPTION OF THE DRAWINGS

FIG. 1 is a perspective view of an exemplary electric heater assembly in accordance with the present invention.

FIG. 2 is a plan view of the electric heater assembly of FIG. 1 showing how the heater assembly can be equipped with clamping hardware and formed into an illustrative circular shape.

FIG. 3 is a partial side view of the circular electric heater assembly of FIG. 2.

FIG. 4 is a partially cut away plan view of a segment of the heating element of the electric heater assembly of FIG. 1.

FIG. 5 is an exploded plan view of one power lead, an end of the heating element and a barrel connector of the electric heater assembly of FIG. 1.

FIG. 6 is a partially cut away plan view of the assembled power lead, heating element and barrel connector of the electric heater assembly of FIG. 1.

FIG. 7 is a plan view of the barrel connector crimped over the corresponding ends of the power lead and the heating element of the electric heater assembly of FIG. 1.

FIG. 8 is a plan view of an elastomeric sealing sleeve of the electric heater assembly of FIG. 1.

FIG. 9 is a plan view of the elastomeric sealing sleeve assembled over the barrel connector and the corresponding ends of the power lead and heating element of the electric heater assembly of FIG. 1.

FIG. 10 is a partially cutaway plan view of the elastomeric sealing sleeve of the electric heater assembly of FIG. 1 showing the elastomeric sleeve filled with a sealing compound.

FIG. 11 is a plan view showing the sealing sleeve assembled over the barrel connector and the corresponding ends of the power lead and heating element of the electric heater assembly of FIG. 1.

FIG. 12 is an exploded perspective view of the electric heater assembly of FIG. 1 showing the assembly of the heating element in the housing.

FIG. 13 is an exploded perspective view of the electric heater assembly of FIG. 1 showing the upper housing portion being assembled to the lower housing portion.

FIG. 14 is a perspective view of one end of an alternative embodiment of an electric heater assembly according to the present invention.

FIG. 15 is a perspective view of a flat blank used to form the upper housing portion of the electric heater assembly of FIG. 16.

FIG. 16 is a perspective view of the upper portion of the heater housing of the electric heater assembly of FIG. 16.

### DETAILED DESCRIPTION OF THE INVENTION

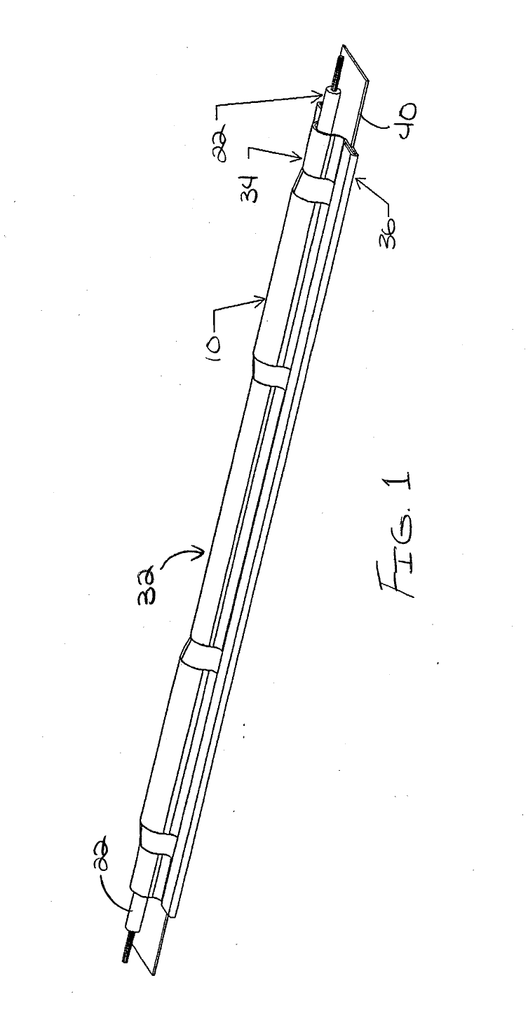

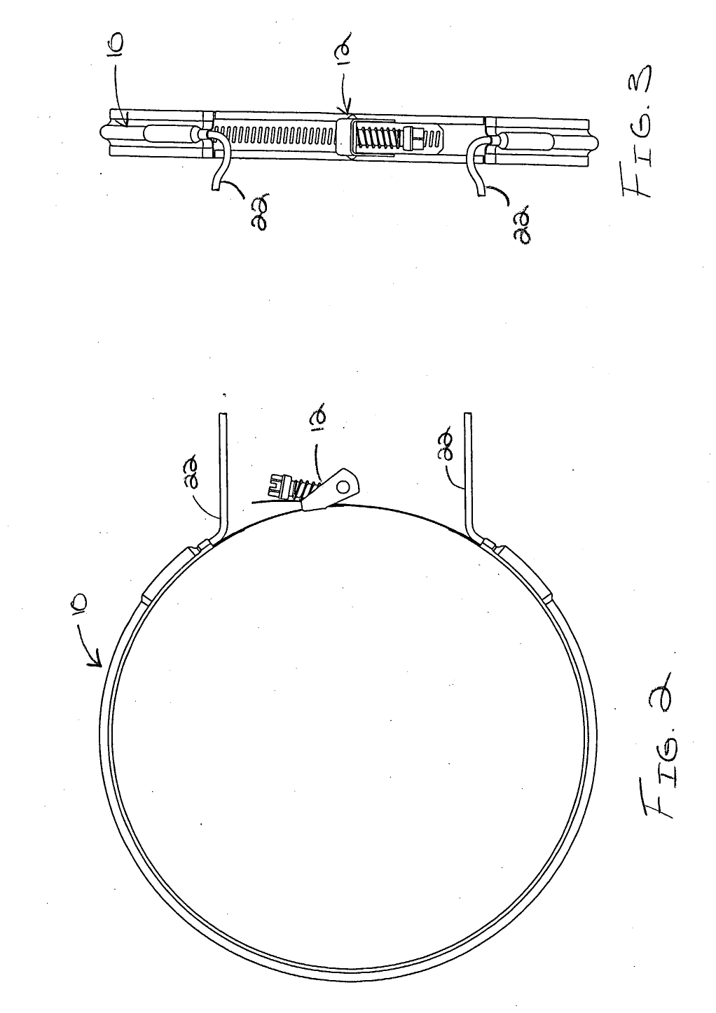

Referring now to FIG. 1 of the drawings there is shown an exemplary electric heater assembly 10 constructed in accordance with the present invention. The illustrated electric heater assembly 10 is configured as an elongated flexible strip or band that can be configured into a variety of shapes as desired to fit a specific application. For example, as shown in FIGS. 2-3, the electric heater assembly 10 can be formed into a circular shape that allows the heater assembly 10 to be wrapped around an object to be heated so as to provide conductive heat transfer from the heater assembly to the object.

To facilitate mounting of the heater assembly 10, mounting hardware such as clamping straps 12 can be attached to the heater assembly as shown in FIGS. 2 and 3 to assist in clamping the heater assembly tightly around the object to be heated, for example, an air conditioning compressor. Of course, while the present invention is described in connection with an electric heater assembly having a band configuration, it will be readily appreciated that aspects of the invention can be applied to electric heater assemblies having different configurations.

For producing heat, the heater assembly 10 includes an electrically powered heating element 14. As shown in FIG. 1, the illustrated heating element 14 generally includes a resistance wire 16 that is helically wrapped around the exterior surface of a cylindrical core 18. The heating element 14 is heated by a flow of electrical current through the resistance wire 16. As will be appreciated, the resistance wire 16 can be made of any suitable electrically conductive material such as, for example, nickel chromium. Moreover, the core 18 can be made of any suitable electrically insulating material such as, for example, fiberglass. To protect the heating element 14 against moisture, the core 18 and resistance wire 16 are covered with a layer of a waterproof insulating material 20 such as an elastomeric material. Silicone rubber is one example of a suitable elastomeric insulating material 20 for the heating element 14.

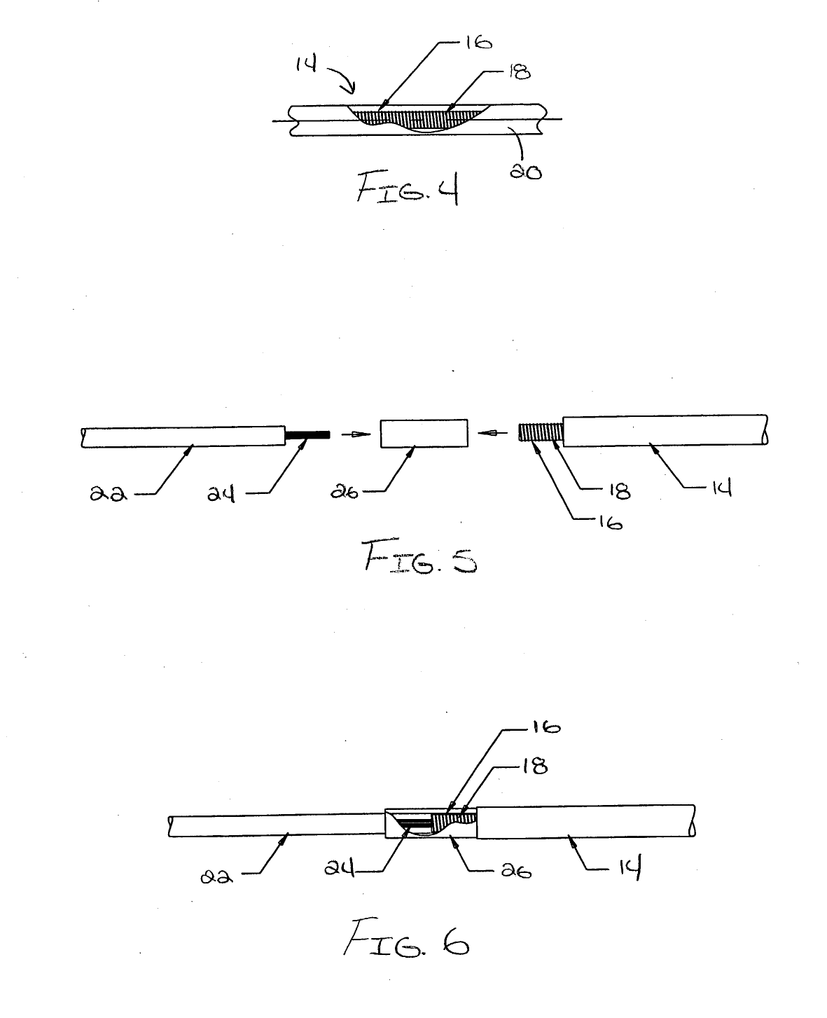

The heater assembly 10 further includes a pair of power leads 22 each of which connects to a respective one of the ends of the heater assembly (see, e.g., FIG. 2) for supplying electric power to the heating element 14. Each of the power leads 22 generally consists of a plurality of internal conducting strands 24 that are encased in a suitable insulating material such as PVC, silicone, neoprene or Teflon®. To facilitate the connection of the power leads 22 to the heating element 14, a length of the insulating material on the power leads 22 is removed from an end of each of the power leads, exposing the internal conducting strands 24 as shown with respect to one end of the heater assembly 10 in FIG. 5. Likewise, a short length of the insulation 20 is removed from the corresponding ends of the heating element 14, revealing the internal resistance wire 16 wrapped around the supporting core 18.

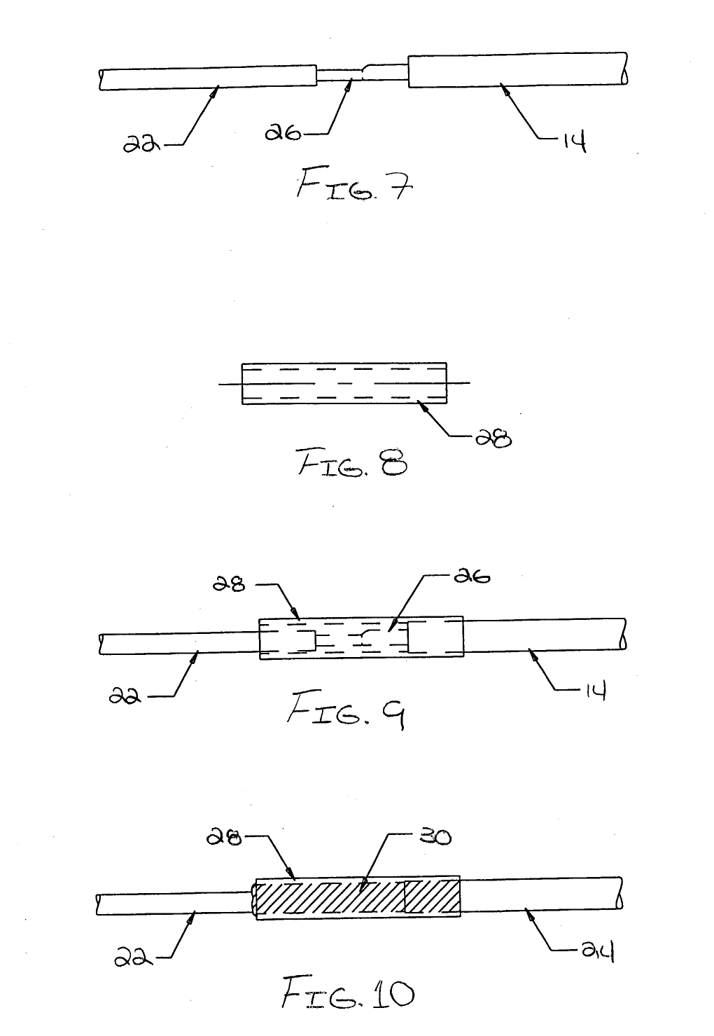

To connect the power leads 22 to the heating element 14, the exposed resistance wire 16 and supporting core 18 at each end of the heating element and the exposed conducting strands 24 of the corresponding power lead 22 are inserted into either end of a respective barrel connector 26 as shown with respect to one end of the heater assembly 10 in FIGS. 5 and 6. In this case, the barrel connector 26 consists of a length of appropriately sized metal tubing having a circular cross-section. As shown in FIG. 7, the barrel connector 26 is then crimped or compressed in order to grasp the resistance wire 16 and supporting core 18 of the heating element 14 and the conducting strands 24 of the power lead 22. The compressed barrel connector 26 mechanically holds the resistance wire 16 and supporting core 18 of the heating element 14 and the conducting strands 24 of the power lead 22 together as well as provides an electrically conductive connection between the two.

In order to enable the electric heater assembly 10 to withstand exposure to water and ice, the connections between the power leads 22 and the heating element 14 can incorporate watertight seals. These watertight seals ensure that the connections between the power leads 22 and the heating element 14 will retain their mechanical and electrical integrity even when the heater assembly 10 is installed in an outdoor application where it will be exposed to adverse weather conditions including rain, snow and ice water or ice or installed in an application where it will be submerged in water. To this end, in the illustrated embodiment, each watertight seal includes a sealing sleeve 28 (see FIG. 8) that can be arranged over the corresponding barrel connector 26. As will be appreciated by those skilled in the art, the sealing sleeves 28 can be made of any suitable elastomeric material such as, for example, silicone rubber. Moreover, the sealing sleeves 28 should have a length, diameter and wall thickness that is suitable for the specific application in which the heater assembly 10 is to be used. In this case, each sealing sleeve 28 is slightly longer than the corresponding barrel connector 26 such that it can be positioned over the barrel connector with a portion of the sleeve overlapping both the power lead 22 and the heating element 14 as shown in FIG. 9 with respect to the connection of one of the power leads. Additionally, the sealing sleeve 28 has an inside diameter that allows it to fit snugly over the end of the heating element 14, the end of the power lead 22 or both.

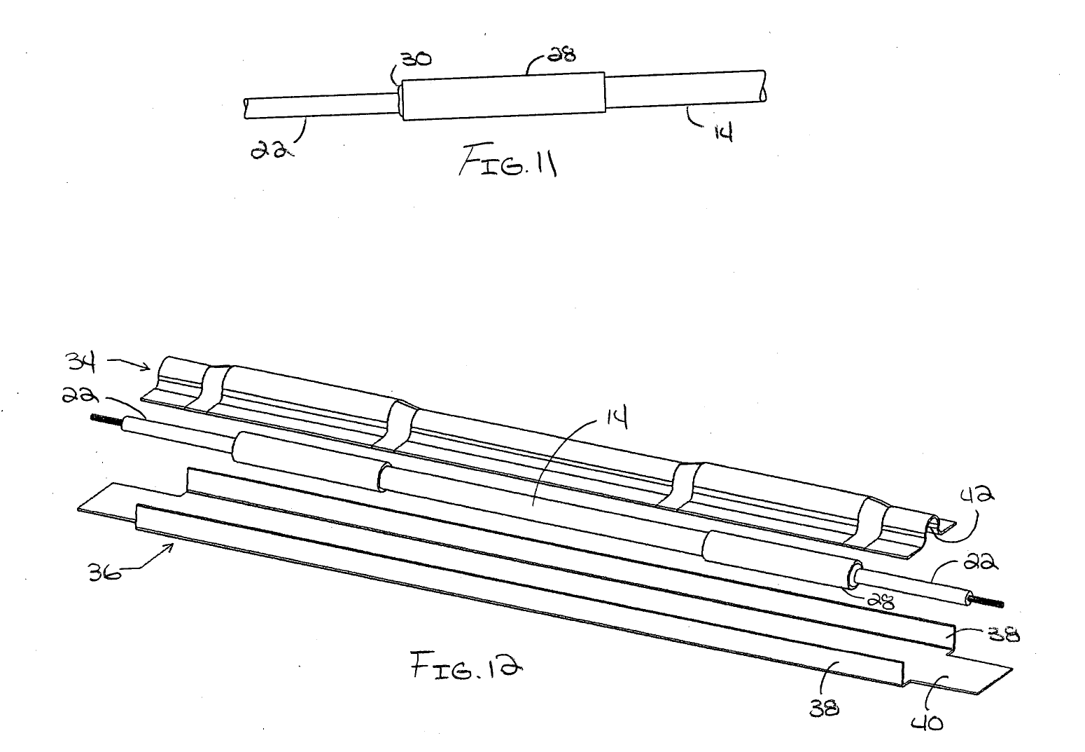

To fill any voids underneath the sealing sleeve 28, a sealing compound 30 can be injected or otherwise inserted into the space between the inner wall of the sealing sleeve 28 and the compressed barrel connector 26, the heating element 14 and the power lead 22 as shown in FIGS. 10 and 11 with respect to the connection of one of the power leads. One example of a suitable method of delivering the sealing compound 30 to the voids underneath the sealing sleeve 28 is using a syringe having a thin hypodermic needle that can fit between the sealing sleeve and the power lead 22 or heating element 14. The snug fit between the sealing sleeve 28 and the power lead 22 and/or the heating element 14 can facilitate this delivery process. In particular, the heater assembly 10 can be positioned vertically with the snug section of the sealing sleeve 28 at the lowest point so that the sealing compound 30 does not leak out of assembly while the voids are being filled. Those skilled in the art will appreciate that other techniques may be employed to fill the sealing sleeve 28 with the sealing compound 30.

The sealing compound 30 can consist of any suitable material such as a room temperature vulcanization (RTV) sealing compound or another curing rubber elastomer product. When cured, the sealing compound should adhere to the outer insulation of the power lead 22 and the outer insulation of the heating element 14 such that moisture cannot penetrate the sealed area to come in contact with the electrical connection therebetween. The sealing compound 30 also should not breakdown, degrade, weaken, liquefy or otherwise fail to provide an adequate seal when exposed to heat (e.g., when the electric heater assembly 10 is energized) or cold (e.g., when the electric heater assembly 10 is located outdoors).

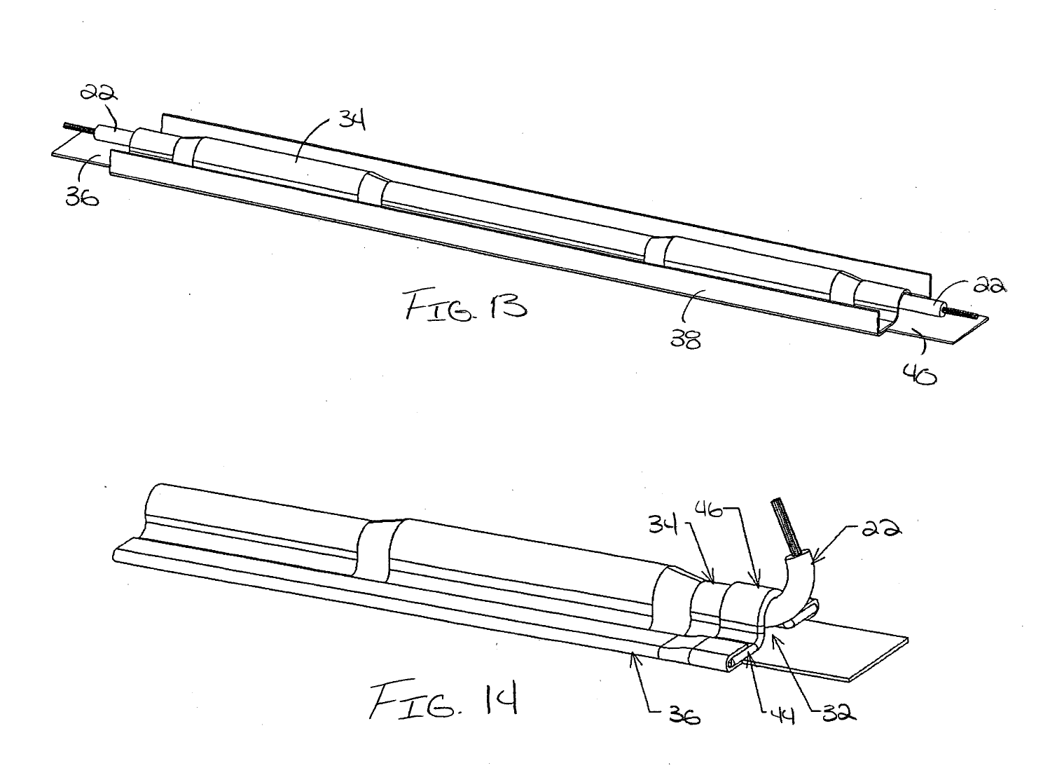

In the illustrated embodiment, the heating element 14 and power lead 22 assembly is contained within a housing 32 that facilitates transfer of the heat produced by the heater assembly to the object to be heated as well as formation of the heater assembly 10 into different shapes. In this case, the housing 32 includes upper and lower housing portions 34, 36 each of which is preferably constructed of a heat conductive material that is sufficiently flexible so as to permit the heater assembly 10 to be formed into different shapes. In the unassembled state, as shown in FIG. 12, the illustrated lower housing portion 36 has a pair of upstanding sidewalls 38 and a flat bottom wall 40. The upper housing portion 34, in turn, includes an axially extending recess or channel 42 that is shaped to conform to the heating element 14 and power lead 22 assembly. This channel or recess 42 has enlarged portions adjacent to either end that correspond to the regions where the heating element 14 is connected to power leads 22 via the barrel connectors 26 and associated watertight seals.

The housing 32 is assembled by positioning the heating element 14 and power lead assembly 22 in the axially extending channel 42 in the upper housing portion 34 and arranging the upper housing portion 34 such that it is resting on the flat bottom wall 40 of the lower housing portion 36 between the upstanding sidewalls 38 as shown in FIGS. 12 and 13. The sidewalls 38 of the lower housing portion 36 are then folded over the edges of the upper housing portion 34 to secure the upper and lower housing portions together and the heating element/power lead assembly therebetween. The heater assembly 10 with the housing fully assembled is shown in FIG. 1. The assembled housing 32 acts as a heat sink drawing heat away from the heating element 14 and transferring it to the object to be heated through the bottom wall 40 of the lower portion 36 of the housing. The broad, flat configuration of the bottom wall 40 of the lower housing portion 36 facilitates this heat transfer process. Advantageously, the joint between the upper and lower portions 34,36 of the housing does not have to be watertight since the watertight seals provided at the connections between the power leads 22 and the heating element 14 prevent water from reaching the electrically charged components of the heater assembly 10.

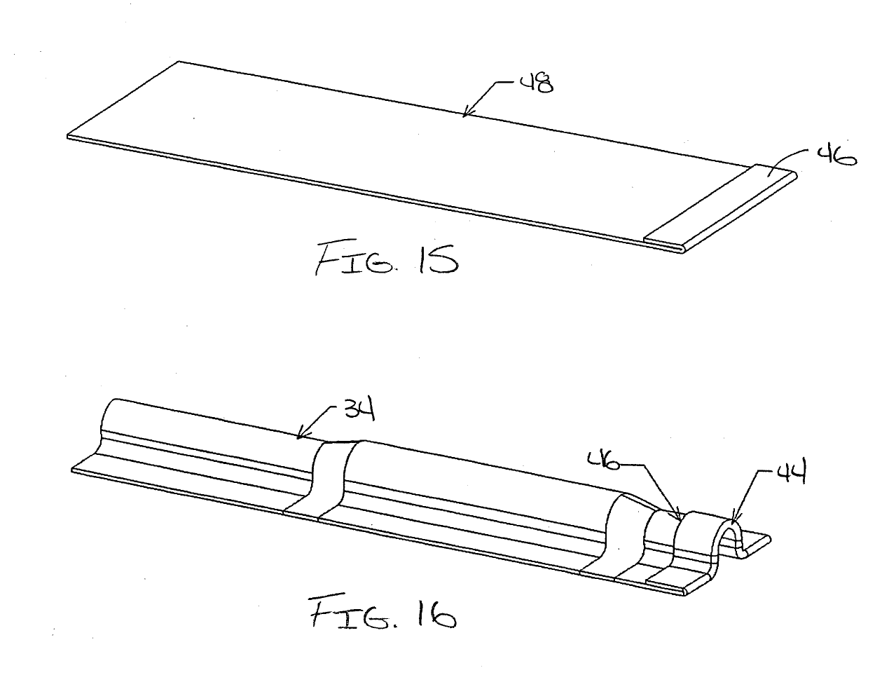

An alternative embodiment of the present invention in which the housing 32 is configured to prevent abrasion damage to the insulation of the power leads 22 at the point at which the power leads exit the housing is shown in FIGS. 14-16. The housings of band-type electric heater assemblies are generally formed from a material such as sheet metal that can present sharp edges. The insulation of the power leads of the heater assembly can be cut or otherwise damaged if it is repeatedly flexed or bent so as to rub against these sharp metal edges. To eliminate the potential for damage to the insulation of the power leads, the ends of the upper housing portion 34 can be formed with smooth rounded edges 44 (see FIG. 14 which illustrates one end of the housing). These smooth rounded edges 44 can be formed by taking a short length of the metal edge of the upper housing portion 34 and folding it back on itself. This moves the sharp edge of the sheet metal away from the point at which the power lead 22 exits the housing 32 to a location where it cannot rub against the power lead. Instead, a smooth rounded edge 44 is provided at the point at which the power lead 22 exits the housing 14 so that if the power lead is flexed or bent to rub against the edge such as shown in FIG. 14, the insulation of the power lead will not be damaged.

The folded-back portion 46 can be produced by taking a flat blank 48 that will be used to make the upper housing portion 34 and bending a desired length of the blank at each end of the blank back onto itself. The bent back portion 46 is than flattened as shown in FIG. 15 (illustrating one end of the blank). The axial channel 42 for receiving the heating element and power lead assembly is then formed into the blank, such as by using a die set or other suitable method. One end of the completed upper housing portion 34 is shown in FIG. 16. It will be appreciated that the blank 48 for the upper housing portion 34 could be formed into any number of final geometries depending on the needs of the application. While the folded back housing edge aspect of the invention has been illustrated with respect to a heater assembly having a watertight seal, this aspect of the invention could be applied to heater assemblies that do not include such a seal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric heater assembly comprising:
an electrically operable heating element;
a pair of power leads for supplying electrical power to the heating element, each power lead being connected to a respective end of the heating element by a connector;
a watertight seal arranged at the connection of each power lead to the heating element, each watertight seal comprising a sealing sleeve arranged over the respective connector and a sealing compound provided between the sealing sleeve and the respective connector; and
a housing within which the heating element, the connectors and the watertight seals are arranged.

2. The electric heater assembly according to claim 1 wherein the electric heater assembly is in the form of an elongated band.

3. The electric heater assembly according to claim 2 wherein the housing is flexible.

4. The electric heater assembly according to claim 1 wherein the heating element comprises a resistance wire helically wrapped around a supporting core.

5. The electric heater assembly according to claim 4 wherein the heating element includes a waterproof outer insulation layer.

6. The electric heater assembly according to claim 1 wherein the housing comprises upper and lower housing portions that are assembled along an unsealed joint.

7. The electric heater assembly according to claim 1 wherein the housing includes a pair of openings with each power lead extending through a respective one of the pair of openings and each of the openings includes a rounded smooth edge defined by a portion of the housing that is folded back on itself.

8. An electric heater assembly comprising:
an electrically operable heating element;
a pair of power leads for supplying electrical power to the heating element, each power lead being connected to a respective end of the heating element; and
a housing within which the heating element and the connections of the heating element to the power leads are arranged, the housing including a pair of openings with each power lead extending through a respective one of the pair of openings, each of the openings including a rounded smooth edge defined by a portion of the housing that is folded back on itself, each of the power leads extending past a respective one of the rounded smooth edges.

9. The electric heater assembly according to claim 8 wherein the electric heater assembly is in the form of an elongated band.

10. The electric heater assembly according to claim 9 wherein the housing is flexible.

11. The electric heater assembly according to claim 8 wherein the heating element comprises a resistance wire helically wrapped around a supporting core.

12. The electric heater assembly according to claim 8 wherein the housing comprises upper and lower housing portions and the folded back portion of the housing is a portion of the upper housing portion.

13. An electric heater assembly comprising an electrically operable heating element, a pair of power leads for supplying electrical power to the heating element, each power lead being connected to a respective end of the heating element, a watertight seal arranged at the connection of each power lead to the heating element and a housing within which the heating element, the connections of the heating element to the power leads and the watertight seals are arranged.

14. The electric heater assembly according to claim 13 wherein the electric heater assembly is in the form of an elongated band.

15. The electric heater assembly according to claim 14 wherein the housing is flexible.

16. The electric heater assembly according to claim 13 wherein the heating element comprises a resistance wire helically wrapped around a supporting core.

17. The electric heater assembly according to claim 16 wherein the heating element includes a waterproof outer insulation layer.

18. The electric heater assembly according to claim 13 wherein the housing comprises upper and lower housing portions that are assembled along an unsealed joint.

19. The electric heater assembly according to claim 13 wherein the housing includes a pair of openings with each power lead extending through a respective one of the pair of openings and each of the openings includes a rounded smooth edge defined by a portion of the housing that is folded back on itself.
